(19) United States
(12) Patent Application Publication
(10) Pub. No.: US 2010/0212463 A1
(43) Pub. Date: Aug. 26, 2010

(54) Pivoting Handle Installation Tool for Assembling Pre-tension Spiral Balances into Window Frames

(75) Inventor: Wilbur James Kellum, III, Hilton, NY (US)

Correspondence Address: BROWN & MICHAELS, PC;400 M & T BANK BUILDING, 118 NORTH TIOGA ST, ITHACA, NY, 14850, US

(73) Assignee: CALDWELL MANUFACTURING COMPANY, Rochester, NY (US)

(21) Appl. No.: 12/392,667

(22) Filed: Feb. 25, 2009

(51) Int. Cl. B25B 23/16; E06B 1/04; B23P 11/00

(52) U.S. Cl. 81/177.1; 52/213; 29/428

(57) ABSTRACT

A tool to facilitate the installation of spiral rod balances after the sash has been installed into the window frame. The tool becomes an extension onto the end of the spiral rod of a conventional spiral rod balance and forms a spiral balance sub-assembly. It enables the installer to pull the end of the spiral rod from its pre-tensioned positioned in the balance containment tube without the necessity of having to use another tool, turn the tool so that a sash clip securely fixed onto the spiral rod is seated the sash rail. The tool can be recycled by the window manufacturer for re-use.

### FIELD OF THE INVENTION

The invention pertains to the field of windows. More particularly, the invention pertains to a tool and its corresponding method for installing pre-tensioned spiral balances in the jamb channels of window frames after installation of the sash into the window frame by a window manufacturer.

### BACKGROUND OF THE INVENTION

Pretension spiral window balances have advantages over un-tensioned balances. Pretension balances are pre-wound and do not require the window manufacturer to manually wind the lift force onto the balance prior to attaching the end of the spiral rod to a window sash. Pretension balances also eliminate the possibility of the window manufacturer applying an incorrect number of windings (lift force) to the balance, which could result in the improper operation or outright failure of the window balance.

When an un-tensioned balance is installed into a jamb channel of a window frame, the rod is free to drop below the window sash and the rod end can be accessed for winding the lift force into the balance and then attached to the window sash. However, this requires special tooling by the window manufacturer and is prone to human error. In a pretension balance, the lifting force is machine wound at the balance manufacturer. Then the pre-wound rod is locked in position by means, for example, of applying torque to the windings of the balance spring and securing the spring inside a special pretension balance anchor located inside the balance containment tube.

After the pretension balance is mounted within the jamb channel of a window frame, the rod end may not be accessible from below the window sash because it is not free to drop below the bottom end of the sash. This makes it difficult for the window manufacturer to attach a standard balance installation tool to the rod end in order to attach the end of the spiral rod to a ledge on the window sash.

There is a need, therefore, for a device to elongate the spiral rod so that it can be pulled below the sash. A clip located at the end of the spiral rod can then be manipulated onto a ledge on the sash. It would also be desirable for such a spiral rod extender device to perform the additional function of the tool that pulls the end of the spiral rod and secures it to the sash. This would significantly ease the assembly of the entire window frame by the window manufacturer.

### SUMMARY OF THE INVENTION

The present device is a tool to assist a window manufacturer with the installation of spiral rod balances after the sash has been installed into the window frame. The present device is a pivot handle attachment tool and provides two essential functions. First, it provides an extension onto the end of the spiral rod of a conventional spiral rod balance. This facilitates the installation of the spiral rod balance within the jamb channel by the window frame manufacturer. Second, it enables the installer to pull the end of the spiral rod from its pre-tensioned positioned in the balance containment tube without the necessity of having to use another tool.

### BRIEF DESCRIPTION OF THE DRAWING

FIG. 1 shows the pivot handle attachment tool for spiral rod balances.

FIG. 2 shows the hook end of the pivot handle attachment tool aligning for engagement with the exposed end of the spiral rod of a spiral rod balance.

FIG. 3 shows the pivot handle attachment tool engaged with the spiral rod.

FIG. 4 shows the pivot handle attachment tool with the handle in the open or “T” position, the pivot handle attachment tool engaged with the spiral rod balance.

FIG. 5 shows the handle of the pivot handle attachment tool in a closed position, parallel to the main shaft of the tool, aligned for insertion into the jamb channel of a window frame.

FIG. 6 shows the pivot handle attachment tool beginning its traversal down the jamb channel with the spiral rod balance following.

FIG. 7 shows the end of the containment tube of the spiral rod balance about to be secured to the wall of the jamb channel by a conventional balance attachment clip and screw.

FIG. 8 shows the pivot handle attachment tool in the jamb channel emerging from the space between the sash and the wall of the jamb channel.

FIG. 9 shows the handle in the open position.

FIG. 10 shows the handle being rotated so that the clip at the end of the spiral rod begins to align with its mating interface on the sash.

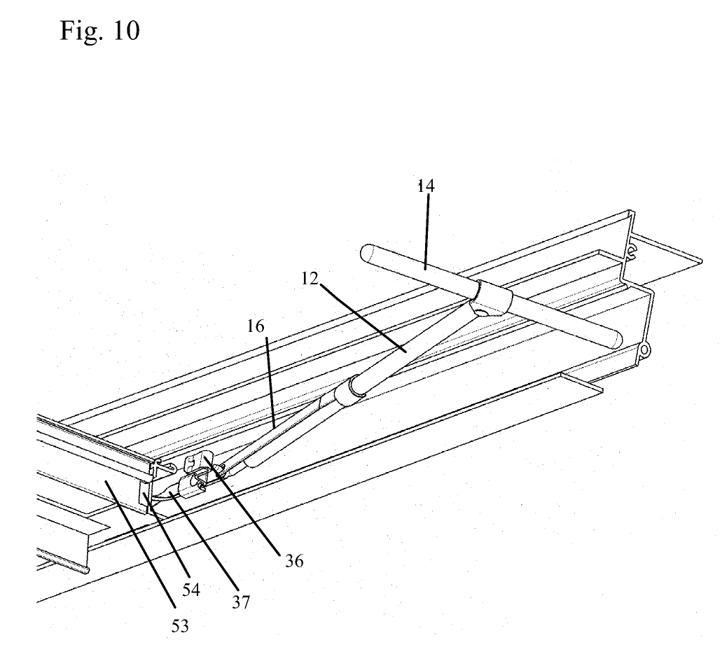

FIG. 11 shows the pivot handle attachment tool securing the spiral rod clip onto the sash interface.

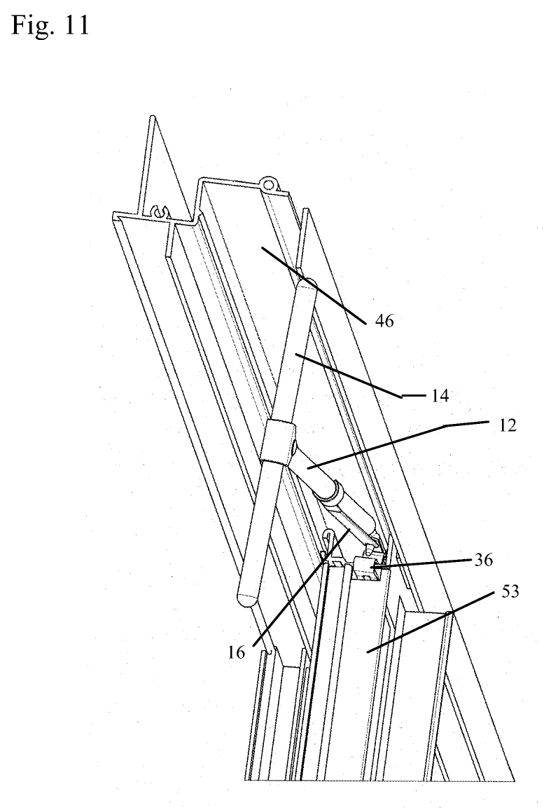

FIG. 12 shows the pivot handle attachment tool being disengaged from the hole in the end of the spiral rod.

FIG. 13 shows the pivot handle attachment tool fully disengaged from the spiral rod balance, the balance now functionally attached to the window assembly.

FIG. 14 shows the pivot handle using a cord to assist in pulling the handle through the jamb channel.

### DETAILED DESCRIPTION OF THE INVENTION

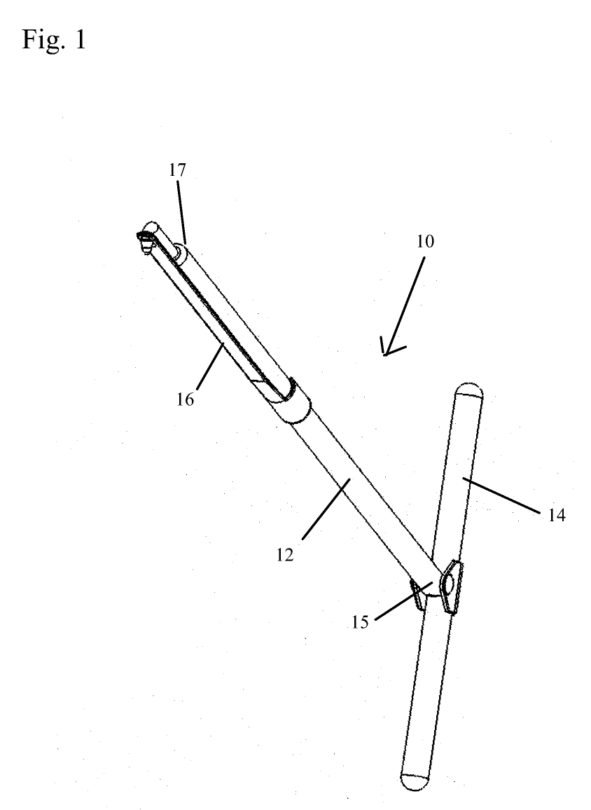

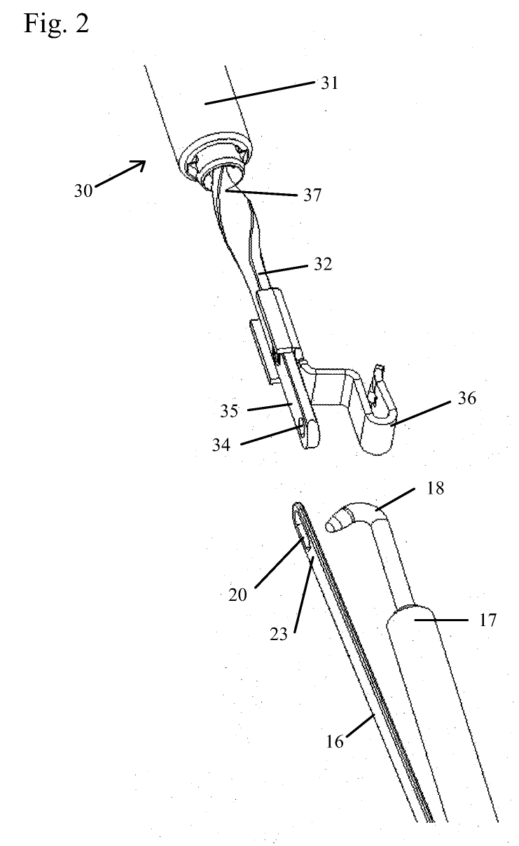

Referring to FIGS. 1 and 2, the pivot handle attachment tool 10 shown herein consists of a main support shaft 12, having a handle 14 pivotally attached at the first end 15. A hook 18 is securely attached to the second end 17 of the main support shaft 12. A first end 21of an elongated strap spring 16 is attached to the main support shaft 12 in proximity to the second end 17 of the main support shaft 12. The elongated strap spring 16 is designed to lie, in its resting position, semi-permanently against the main support shaft 12. The second end 23 of the elongated strap spring 16 has a strap spring hole 20 that is aligned with the tapered tip of the hook 18.

The spiral balance 30 that is used in conjunction with the pivot handle attachment tool 10 consists of a containment tube 31, within which is contained a spiral rod 32 and a spiral spring (not shown). The exposed end 35 of the spiral rod 32 has a spiral rod hole 34. Between the spiral rod hole 34 and the turns 37 of the spiral rod 32 a sash clip is securely fastened.

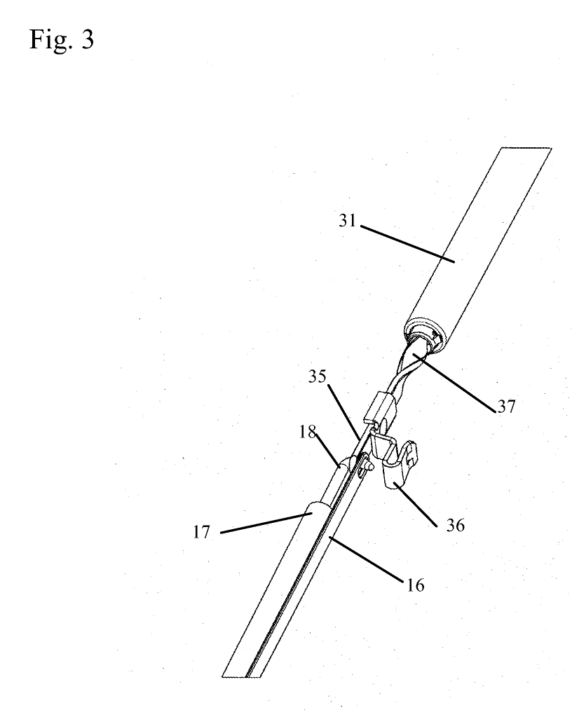

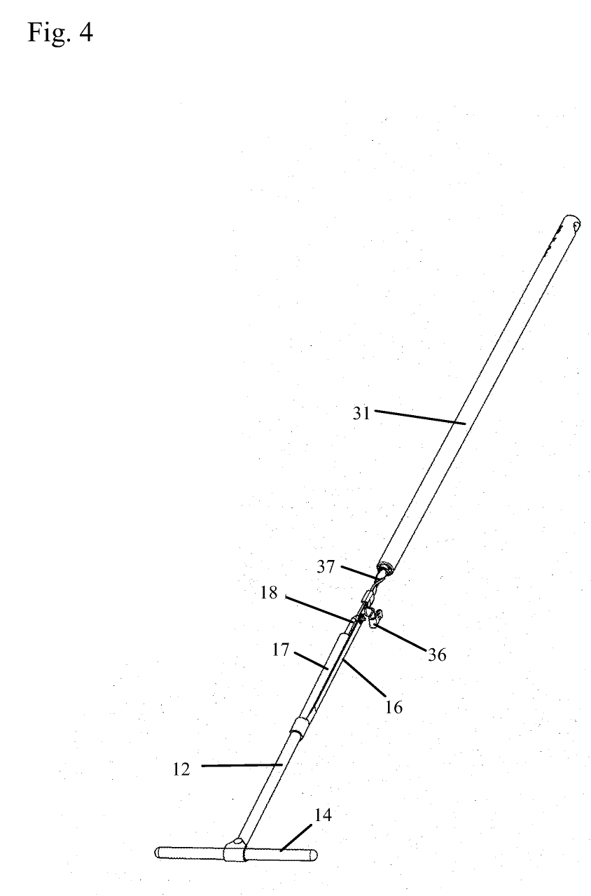

To connect the pivot handle attachment tool 10 to the spiral balance 30 to form a spiral balance sub-assembly, the elongated strap spring 16 is manually pulled away from hook 18 so that a gap now exists between the tip of the hook and the elongated strap spring. The tip of the hook 18 is then inserted through the spiral rod hole 34. The elongated strap spring 16 is then allowed to return to its resting position in abutment with the main support shaft 12 to non-permanently secure the pivot attachment tool 10 to the spiral rod 32 by insertion of the hook 18 first through the spiral rod hole 34 then through the strap spring hole 20 (please refer to FIGS. 3 and 4). This procedure may be performed by either the balance manufacturer or the window manufacturer. Preferably, however, the balance manufacturer attaches the pivot handle attachment tool 10 to the spiral balance 30, then ships the joined elements 10 and 30 to the window manufacturer or to the site of window manufacture, such as to the building construction site.

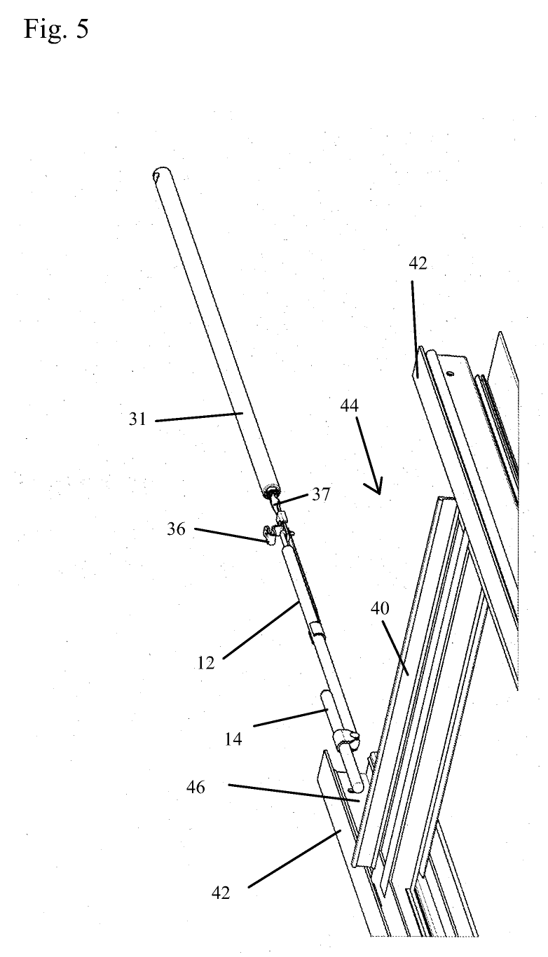

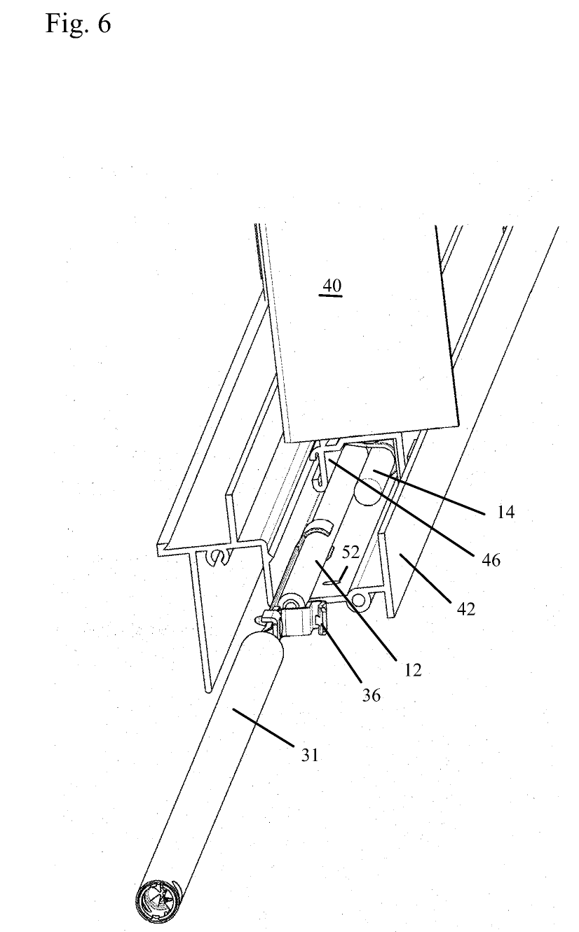

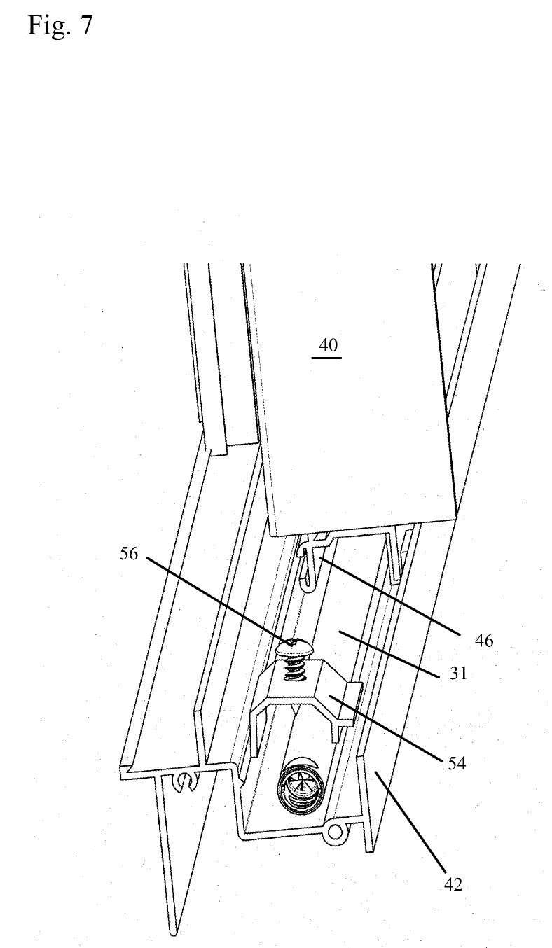

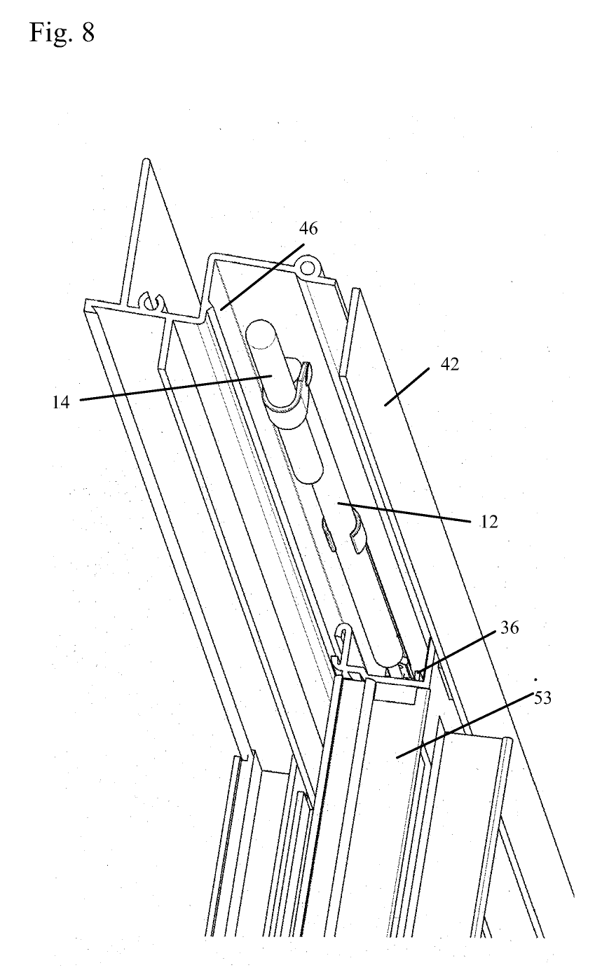

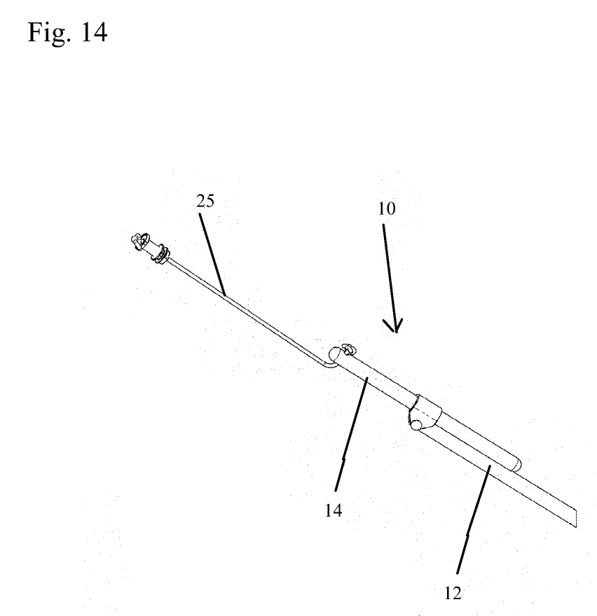

Referring to FIGS. 5 and 6, once the sash 44 is installed within the jambs 42 of the window frame, the pivot handle attachment tool 10 is oriented for insertion into the jamb channel 46. The handle 14 of the pivot handle attachment tool 10 is pivoted into parallel abutment with the main support shaft 12. The handle 14 is then inserted into the top end of jamb channel 46 and urged down the jamb channel until the closed end 48 of containment tube 31 aligns with a mounting hole 52 in the wall of jamb channel 46. In cases where access into the jamb channel is restricted, a rope or cord 25 may be secured to one end of the handle 14 to assist with drawing the pivot handle attachment tool 10 out of the jamb channel (See FIG. 14). Conventional retention means, such as, for example, a clip 54 and screw 56 (shown in FIG. 7) secure the containment tube 31 to the wall of the jamb channel 46. The first sash rail 40 is then urged to abut a sash stop (not shown), located in proximity to the end of the jambs 42 to which the closed end 48 of the containment tube 31 is secured, thus exposing the pivot handle attachment tool 10 at the opposite end of the sash 44 within the jamb channel 46 (see FIG. 8).

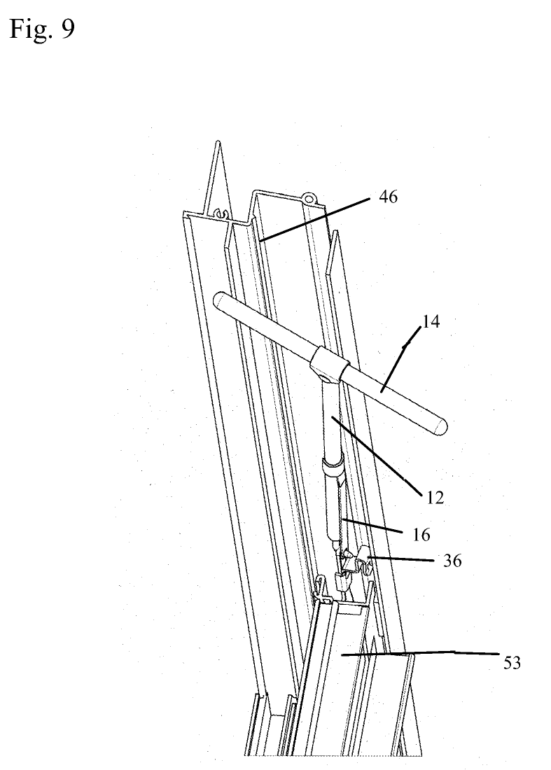

The window installer then pivotally rotates the handle 14 so that it forms a “T” shaped configuration with respect to the main support shaft 12, as shown in FIG. 9. The pivot handle attachment tool 10 is then rotated to orient the sash clip 36 into alignment with a mating clip interface 54 on the second rail 53 of sash 44. Since the spiral rod 32 is under tension (from the pre-tensioning operation performed by the tension manufacturer), it is allowed to retract back into the containment tube 31, thus securely abutting the sash clip 36 to the rail 53 of sash 44.

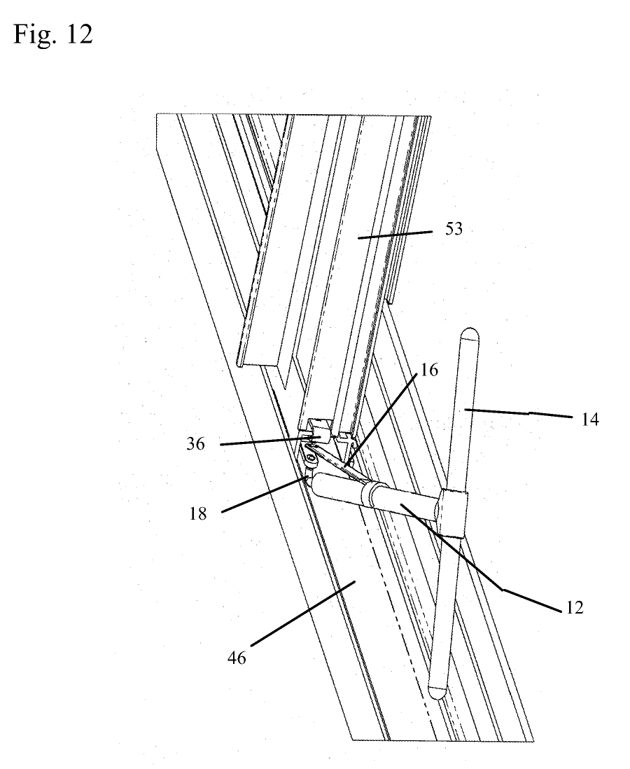

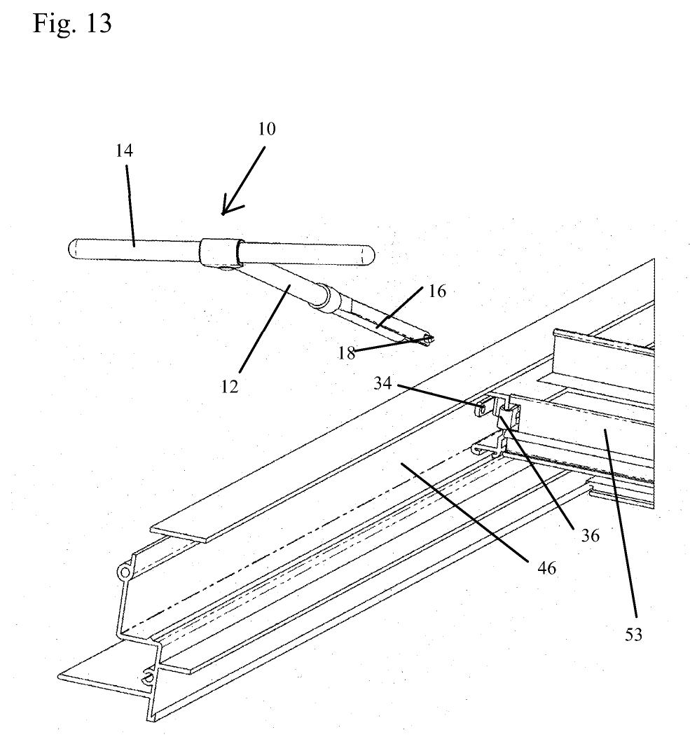

To remove the pivot handle attachment tool 10, the elongated strap spring 16 may either be manually pulled away from the spiral rod 32 or the pivot handle attachment tool 10 is oriented (please see FIG. 12) such that the elongated strap spring 16 is urged away from the spiral rod 32 and the tip of the hook 18 is allowed to slip out from the strap spring hole 20 and the spiral rod hole 34. With the installation of the spiral balance 30 in the jamb channel 46 of the window frame, the pivot handle attachment tool 10 is free, as shown in FIG. 13, and may be reused by the window manufacturer for installation onto new pre-tension spiral balances.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. In a spiral balance, a tool for assembling the spiral balance in a jamb channel of a window frame comprising:
a) a main support shaft having a first end and a second end, the first end of the main support shaft being pivotally connected to a handle, the second end of the main support shaft terminating in a hook, the hook having a tapered tip; and
b) an elongated strap spring, having a first end and a second end, the first end of the elongated strap spring being securely connected to the main support shaft in proximity to the second end of the main support shaft; the second end of the elongated strap spring having a hole for receiving the tip of the hook.

2. The tool of claim 1 wherein the first end of the main support shaft pivotally connects with the handle in proximity to the middle of the handle.

3. A spiral balance sub-assembly for windows, wherein the spiral balance consists of a spiral rod within a containment tube, the containment tube having an open end and a closed end, the spiral rod having an end in proximity to the open end of the containment tube, the end of the spiral rod having a hole in proximity to its open end and, optionally, an extension spring surrounding the containment tube, the spiral balance sub-assembly comprising:
a) a spiral balance; and
b) a tool
i) comprising a main support shaft, the main support shaft having a first end and a second end, the first end of the main support shaft being pivotally connected to a handle, the second end terminating in a tapered hook;
ii) an elongated strap spring, having a first end and a second end, the first end of the elongated strap spring being securely connected to the main support shaft in proximity to the second end of the main support shaft, the second end of the elongated strap spring having a hole;
wherein the tip of the hook traverses through the hole in end of the spiral rod and the hole in the second end of the elongated strap spring, such that the spiral rod of the spiral rod balance is non-permanently secured between the hook and the elongated strap spring.

4. A method for assembling the spiral balance sub-assembly of claim 3 within a jamb channel of a window frame, wherein the window frame consists of two opposing parallel jambs, the two jambs containing a first sash rail and a second sash rail, the jamb channel having a first end and a second end, the method comprising the sequential steps of:
a) pivoting the handle so that a portion of the handle abuts the main support shaft;
b) orienting the end of the handle for insertion into the first end of the jamb channel;
c) urging the spiral balance sub-assembly down the jamb channel in the direction of the second end of the jamb channel;
d) urging the sash toward the first end of the jamb channel until the first sash rail abuts a sash stop in proximity to the first end of the jamb channel until the tool is exposed beyond the second sash rail;
e) securing the containment tube of the spiral balance to a wall of the jamb channel;
f) pivoting the handle of the tool until the handle forms substantially a “T” shape with respect to the main support shaft;
g) rotating the handle so that a clip securely affixed to and in proximity to the end of the spiral rod is aligned with a clip interface located on the second rail or stile of the sash;
h) permitting the clip to seat onto the clip interface; and
i) orienting the tool so that it detaches from the spiral rod.

5. The method of claim 4 wherein the closed end of the containment tube is attached to the wall of the jamb channel.

6. The method of claim 5 wherein containment tube is attached using conventional retention means.

7. The method of claim 6 wherein the conventional retention means are the combination of a clip and a screw.

8. The method of claim 4 wherein the tool is oriented so that the hook is removed from the hole in the end of the spiral rod and the hole in the elongated strap spring.
